(19) United States
(12) Patent Application Publication
(10) Pub. No.: US 2006/0124389 A1
(43) Pub. Date: Jun. 15, 2006

(54) Fall-arresting safety harness with an improved buckle

(76) Inventor: John D. Wydner, Danville, AL (US)

Correspondence Address: LANIER FORD SHAVER & PAYNE, P O BOX 2087, HUNTSVILLE, AL, 35804, US

(21) Appl. No.: 11/043,417

(22) Filed: Jan. 26, 2005

(51) Int. Cl. A62B 35/00

(52) U.S. Cl. 182/3

(57) ABSTRACT

A safety harness for use by those engaging in activities at a height above the ground is provided. Such safety harness comprises a plurality of vertical straps, including two shoulder straps and at least two horizontal straps for creating the basic skeletal structure of the harness. The harness is constructed so as to allow for the adjustment of the horizontal straps in relation to the vertical straps for both the security and comfort of the user during the harnesses' period of use. An improved buckle arrangement is additionally provided to enhance the strength of the harness against the forces incurred during a fall arresting maneuver. Such buckle arrangement incorporates a receiver and slider or tongue plate system so as to reduce the likelihood of buckle failure during periods of maximum stress.

### BACKGROUND OF THE INVENTION

The present invention relates to the field of safety equipment. More particularly, the present invention relates to safety hunting harnesses in general. Most particularly, the present invention relates to an improved buckle for an adjustable with a fall arresting safety harness.

In cases where an individual is engaging in activity at an elevation, sitting or standing on a support, it is common to wear a harness on the upper body and to tether such harness to a fixed object. Should the support fail or the user slip, s/he will fall only a short distance and be suspended from the fixed object, thereby avoiding injury from a fall to the ground. One example of such a use of a safety harnesses includes a hunter elevated above the ground on a tree stand, tethered to the tree with a harness worn around the upper torso.

Safety harnesses combined with garments are known. These safety garments are designed to overcome the inconvenience of a harness that has many loops and straps, having a tendency to become twisted and entangled with one another. Adorning such a harness can be relatively time consuming and tedious. When the harness is inside, outside, or between inner and outer layers of a garment, however, the various loops and straps are more resistant to twisting and knotting and thus putting on the harness becomes as easy as putting on a jacket.

One problem with safety garments having harnesses affixed thereto is that they are often difficult to adjust to the user's body. Such garments typically require access to buckles inside the garment that have to be adjusted by trial and error to get a suitable fit. One such garment that avoids this problem is the Hunter Safety Systems combination safety harness and garment as disclosed in U.S. Pat. No. 6,637,547, which is fully incorporated herein by reference. As is typical of many other safety harnesses, the buckles are a commonly referred to as clip and clasp systems wherein a receptacle having a plurality of openings receives an inverted omega-shaped tab. The legs of the inverted omega-shaped tab are compressed during insertion into the receptacle and snap open and are simultaneously inserted into opposing openings in the side of the receptacle thus locking the receptacle and tab together. The tab may be removed by compressing the ends of the legs of the omega-shaped tab together and sliding it out of the receptacle.

Such clip and clasp systems are used in many applications in which a limited potential force is to be exerted on the buckle itself Unfortunately, in the hunting safety harness industry, such buckles are intended to be subjected to heightened forces as the harness serves to arrest the fall of a user. In essence, the harness and thus the buckles retaining the user must be capable of withstanding several times the weight of a given user. The typical clip and clasp system is sufficient for a normal sized adult male but larger individuals can potentially stress the harness beyond its design load limits. As such the present invention recognizes the shortcomings associated with the present state of the art buckles used in such safety harnesses and provides an improved safety harness buckle.

### SUMMARY OF THE INVENTION

The present invention recognizes and addresses various of the foregoing limitations and drawbacks, and others, concerning buckle arrangements presently used in safety harnesses. Therefore, the present invention is directed to an improved buckle for use in harnesses both individually and as affixed to or within a garment.

In one exemplary embodiment of the present invention, there is provided a safety harness for use by individuals engaging in an activity in an elevated location such as hunting from a tree stand or raised platform, such harness provided with an improved buckle arrangement so as to improve the strength of the harness during an emergency. The present exemplary embodiment is a garment comprising an outer shell having a safety harness affixed to the inside of such garment. Alternatively, such harness could be either affixed to the exterior of the garment or located between an inner and an outer layer of the shell.

The harness of the present exemplary embodiment is provided with one or more vertical back straps and vertical shoulder straps. Each of such vertical straps includes a plurality of loops, preferably two; one located at chest level and one located at waist level. A first horizontal strap is slidably inserted through the loops at the level of the chest and a second horizontal strap is slidably inserted through the loops at the level of the waist to form the basic skeletal structure of the harness.

In order to close the basic skeletal structure of the harness about the upper torso of the user, each of the horizontal straps is provided with buckle arrangement for maintaining the straps is a closed loop about the user. At or about one end of each of the first and second horizontal straps is provided a slider or tongue plate. The opposing ends of the first and second horizontal straps are provided with a buckle for receipt of their strap's respective slider or tongue plate. The length of each of the horizontal straps is adjusted by use of an adjustment means located near the end of the strap having the slider or tongue plate. The strap is feed through the adjustment means, then through an opening in the slider or tongue plate, is feed back through the adjustment means and finally is affixed back onto itself. This arrangement, which is well known in the art, allows for the frictional retention of the strap at a user designated length through the use of the adjustment means.

The horizontal position of the buckle arrangement at the front of the garment is intended to ease the initial donning of the harness, however, such placement may be adjusted as desired by sliding the horizontal straps to the left or right without twisting or otherwise deforming the shell of the garment. Such capability is possible because the horizontal straps are free to slide through the loops in the vertical straps (i.e., they are not affixed in place within either the harness or the garment) and ensures a more comfortable fit for the user. Despite the lack of permanent affixation of the horizontal straps to the harness, their combination provides excellent support and protection when a user is suspended from a support object such as a tree. Additionally, the top of the vertical back strap has a loop for attachment of a tether or lanyard suitable for connection to such a supporting object. Further, the bottom of the vertical back strap has a loop for attachment of a tether for towing an object.

Having described at least one exemplary embodiment of the present invention, it is herein proclaimed that a primary object of the present invention is to provide a safety harness for users engaging in activities at a height. In such context it is a principle object of the present invention to provide such a harness with an improved buckle arrangement. Further in such context, it is an object of the present invention to provide such an improved buckle arrangement that significantly enhances the safety of the user.

Another principle object of the present invention is the provision for a safety harness partially affixed to a garment for easing the use of such harness by preventing twisting and knotting of the various straps forming the harness. In such context, it is an object of the present invention to provide such a harness suitable for affixation inside, outside or within internal layers of such a garment. Still further, it is a principle object of the present invention to provide a safety harness/garment combination that is both easy and comfortable to use.

Yet another principle object of the present invention is the provision of a strengthened buckle arrangement over the commonly used clip and clasp systems. In such context, it is an object of the present invention to provide a safety harness incorporating a buckle arrangement having a receiver and a slider or tongue plate for insertion therein. Further in such context, it is an object of the present invention to provide such a buckle arrangement with an easy push button release so as to enable a user to release such horizontal straps after recovering from a fall from a height or to release themselves, if necessary, during such a recovery.

Additional objects and advantages of the invention are set forth in, or will be apparent to those of ordinary skill in the art from, the detailed description as follows. Also, it should be further appreciated that modifications and variations to the specifically illustrated and discussed features and materials hereof may be practiced in various embodiments and uses of this invention without departing from the spirit and scope thereof, by virtue of present reference thereto. Such variations may include, but are not limited to, substitutions of the equivalent means, features, and materials for those shown or discussed, and the functional or positional reversal of various parts, features, or the like.

Still further, it is to be understood that different embodiments, as well as different presently preferred embodiments, of this invention, may include various combinations or configurations of presently disclosed features, elements, or their equivalents (including combinations of features or configurations thereof not expressly shown in the figures or stated in the detailed description).

These and other features, aspects and advantages of the present invention will become better understood with reference to the following descriptions and appended claims. The accompanying drawings, which are incorporated in and constitute a part of this specification, illustrate an embodiment of the invention and, together with the descriptions, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1a is a cross-sectional view of a garment showing the vertical straps, including the shoulder straps, of an exemplary embodiment of the present invention;

FIG. 1b is a cross-sectional view of the garment as depicted in FIG. 1a further showing the insertion of the horizontal straps to form the complete safety harness of such exemplary embodiment of the present invention;

FIG. 2 is an exploded view of one exemplary embodiment of an improved buckle arrangement for use in the present invention; and

FIG. 3 is an exploded view of an alternative exemplary embodiment of an improved buckle arrangement for use in the present invention.

Repeat use of reference characters throughout the present specification and appended drawings is intended to represent the same or analogous features or elements of the various exemplary embodiments of the present invention described and shown.

### DETAILED DESCRIPTION OF THE PREFERRED EMBODIMENTS

Reference will now be made in detail to presently preferred embodiments of the invention, examples of which are fully represented in the accompanying drawings. Such examples are provided by way of an explanation of the invention, not limitation thereof. In fact, it will be apparent to those skilled in the art that various modifications and variations can be made in the present invention, without departing from the spirit and scope thereof. For instance, features illustrated or described as part of one embodiment can be used on another embodiment to yield a still further embodiment. Still further, variations in selection of materials and/or characteristics may be practiced, to satisfy particular desired user criteria. Thus, it is intended that the present invention cover such modifications and variations as come within the scope of the present features and their equivalents.

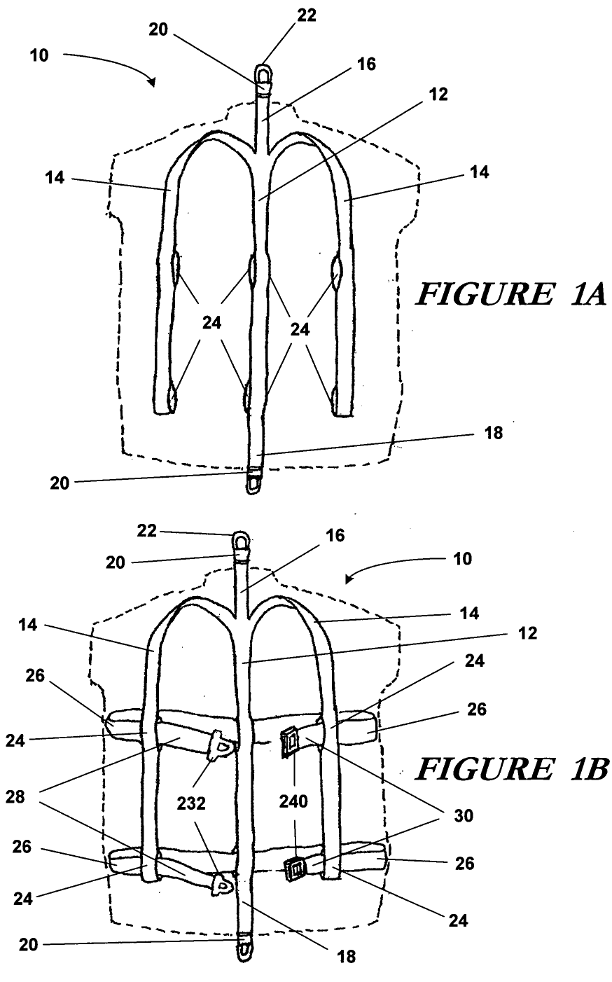

As disclosed above, the present invention is particularly concerned with a safety harness incorporating an improved buckle arrangement. FIG. 1a shows an exemplary embodiment of the harness 10 of the present invention. The harness 10 has at least one vertical back strap 12 and two vertical shoulder straps 14. While the harness 10 may have more than one vertical back strap 12, in the present exemplary embodiment only one is provided. Additionally, leg straps (not shown) may be provided but do not form a portion of the present exemplary embodiment. Vertical back strap 12 has a top end 16 and a lower end 18. Located at ends 16 and 18 are loops 20. The loop 20 at top end 16 is for connection of a D-ring 22 and/or other securement device, such as a lanyard or tether, which is attached to a support object (not shown). Such support object is used to secure the user and thus prevent a fall from their elevated position to the ground. Loop 20 at the lower end 18 of vertical back strap 12 is for attachment of a towing means, a rope or other securement means (not shown), to aid in the movement of large objects, such as deer or other big game when hunting.

The vertical back strap 12 and vertical shoulder straps 14 have one or more loops 24. In the present exemplary embodiment such loops 24 are both chest and waist level. As depicted in FIG. 1b, the present exemplary embodiment of harness 10 is provided with horizontal straps 26 inserted through loops 24 of vertical back strap 12 and vertical shoulder straps 14. Each horizontal strap 26 has a first end 28 and an opposite second end 30. Generally, the first end 28 is attached to a slider or tongue plate 232 and second end 30 is attached to a receiver 240.

More specifically, at or near the first end 28, each of the horizontal straps 26 are respectively weaved through an associated adjustment means 36 then fed through an opening 238 on said slider or tongue plate 232 and then fed back through said adjustment means 36 and finally is permanently affixed to itself. Such arrangement provides the capability of slidably adjusting the length of each of the respective horizontal straps 26 by moving the adjustment means 36 in relation to its respective strap 26 and simultaneously allowing the slider or tongue plate 232 to remain at the first end 28 of the horizontal strap 26. Such length is maintained merely through the frictional force the horizontal strap 26 encounters against itself due to its multiple passages through the adjustment means 36.

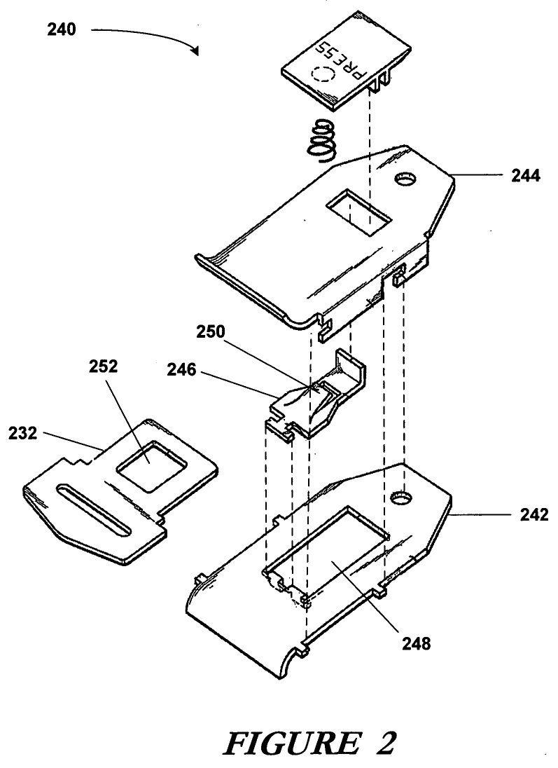

At the second end 30 of each horizontal strap 26 is provided a receiver 240 for receipt of said slider or tongue plate 232. One preferred embodiment of the receiver 240, as best seen in FIG. 2, shows a receiver 240 made up of a housing (not shown) surrounding a base plate 242 and a cover plate 244 with a latch member 246 therebetween. The base plate 242 and the cover plate 244 are connected by either a rivet or other attachment means. The base plate 242 is formed with a recess 248 that is longer and wider than the latch member 246 that is articulatingly linked to the base plate 242 and that has a raised latch 250 that engages in a recess 252 formed in the slider or tongue plate 232 when the latter is inserted into a locking position in the receiver 240.

Due to the large surface area of the slider or tongue plate 232, the base plate 242 and the cover plate 244, as well as the limited translational room for the tongue plate 232 to move when inserted between the base and cover plates 242 and 244, the present exemplary embodiment significantly increases the forces against which it can maintain its locked position during a fall-arresting event. Additionally, while the tongue plate 232 and the receiver 240 may be made of any suitable material, it is preferred that important components thereof such as the tongue plate 232, the base plate 242, the cover plate 244, and the latch member 246 are made of a material sufficient to withstand loads in excess of several hundred pounds acting to pull the receiver 240 and tongue plate 232 apart. One such material is steel.

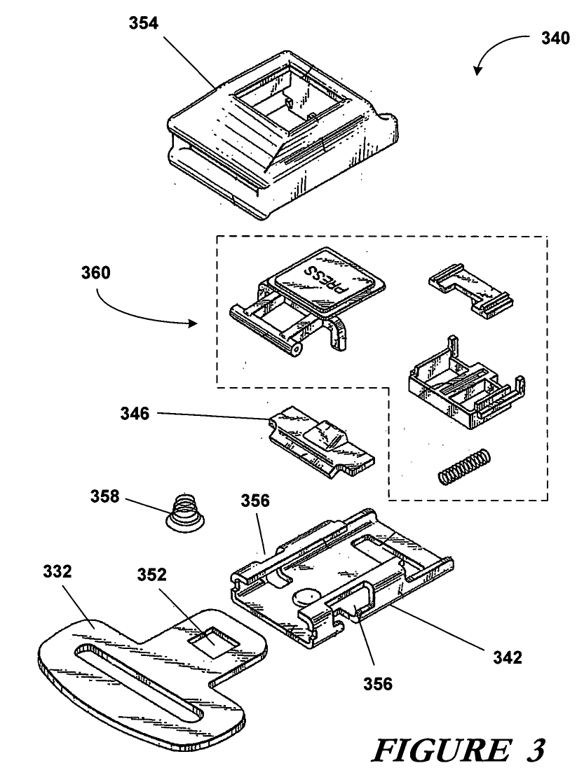

An alternative exemplary embodiment of the receiver 340 of the present invention is shown in FIG. 3, in which the receiver 340 is comprised of a housing 354 surrounding a base plate 342 and a latch mechanism 346, which is loosely maintained within a pair of opposed openings 356 in the rolled edges of base plate 342. The base plate 342 is provided with a coil spring 358 that biases latch mechanism 346 upward into recess 352 formed in the slider or tongue plate 332 when the latter is inserted into a locking position in the receiver 340. The present exemplary embodiment is provided with an ejection mechanism 360 to aid in the removal of the tongue plate 332 when the latch mechanism 346 is forced against the coil spring 358 by pushing on button 362 and thus is removed from the recess 352 in tongue plate 332.

Although several preferred embodiments of the present invention have been described using specific terms and devices, such descriptions are for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of various other embodiments may be interchanged both in whole or in part. Therefore, the spirit and scope of the appended claims should not be limited to the description of the preferred versions contained herein.

1. A fall-arresting safety harness with an improved buckle arrangement comprising:
a) at least one vertical back strap having a top end and a bottom end;
b) a plurality of vertical shoulder straps, said at least one vertical back strap and said plurality of vertical shoulder straps being integrally formed and secured together near said top end of said at least one vertical back strap and wherein said at least one vertical back strap and said plurality of vertical shoulder straps are each provided with a plurality of loops therein;
c) a plurality of horizontal straps suited for passage through said plurality of loops in said at least one vertical back strap and said plurality of vertical shoulder straps and wherein each of said plurality of horizontal straps has a first end and a second end; and
d) said buckle arrangement comprising a tongue plate and a receiver.

2. A fall-arresting safety harness as in claim 1, wherein said tongue plate is suited for insertion into said receiver and wherein said receiver includes a base plate for articulated support of a latch mechanism capable of securing said tongue plate in a releasably locked position upon insertion into said receiver.

3. A fall arresting safety harness as in claim 2, wherein said tongue plate is released from said locked position by activation of a push-button release mechanism.

4. A fall-arresting safety harness as in claim 3, wherein said push-button release mechanism is spring-biased to reversibly articulate said latch mechanism so as to allow the removal of said tongue plate from said receiver.

5. A fall-arresting safety harness as in claim 4, wherein said receiver further comprises an ejection mechanism for forcibly ejecting said tongue plate from said receiver upon activation of said push-button release mechanism.
